(19) United States
(12) Patent Application Publication
(10) Pub. No.: US 2014/0034400 A1
(43) Pub. Date: Feb. 6, 2014

(54) TRACKED MOBILITY DEVICE

(71) Applicant: Freedom One Mobility LLC, North Vernon, IN (US)

(72) Inventors: Travis Underwood, North Vernon, IN (US); Robert W. Davignon, Terre Haute, IN (US); Timothy Joseph Balz, Mooresville, IN (US); Benjamin Robert Low, Terre Haute, IN (US)

(21) Appl. No.: 14/024,956

(22) Filed: Sep. 12, 2013

Related U.S. Application Data
(63) Continuation-in-part of application No. 13/765,182, filed on Feb. 12, 2013.
Application No. 13/765,182 is a continuation-in-part of application No. 12/849,897, filed on Aug. 4, 2010, now Pat. No. 8,371,403.
(60) Provisional application No. 61/231,160, filed on Aug. 4, 2009.

(51) Int. Cl. A61G 5/06; A61G 5/04

(52) U.S. Cl. CPC A61G 5/066; A61G 5/04
USPC 180/9.34

(57) ABSTRACT

A tracked mobility device includes a frame, a pair of track drives connected to the frame, and a rear wheel assembly that is independent of the track drives. Each track drive has a flexible track rotating around a set of wheels, with each set of wheels including a rear powered wheel, a central weight-bearing wheel, and a front roller wheel. The wheels are fixed to the frame at a height effective to cause the track drive always to have a “V”-shaped lower surface when viewed from the side. The independent rear wheel is at a fixed and constant height with respect to the frame, with the fixed and constant height being effective to allow the rear wheel to cooperate with the lowered central portion of each of said track drives to provide a three-point contact with a flat surface.

### REFERENCES TO RELATED APPLICATIONS

This application is a continuation-in-part of U.S. patent application Ser. No. 13/765,182, filed Feb. 12, 2013 (pending), which is a continuation-in-part of U.S. patent application Ser. No. 12/849,897, filed Aug. 4, 2010 (now U.S. Pat. No. 8,371,403), which claims the benefit of U.S. Provisional Application No. 61/231,160 filed, Aug. 4, 2009 (now expired), all of which are hereby incorporated herein by reference.

### FIELD OF THE INVENTION

The present invention relates generally to devices for transporting an individual, and more particularly to a personally mobility device that is powered by a track or pair of tracks.

### BACKGROUND

Military veterans are increasingly returning from assignment overseas with injuries that compromise their ability to participate in outdoor activities such as hunting and fishing. While personal mobility devices with room for one user and a small amount of cargo are known, those devices typically do not allow the mobility and stability that is needed by veterans who desire to be active in spite of injuries to their legs. For example, prior art wheeled mobility devices cannot traverse rough or uneven terrain, and prior art tracked mobility devices typically contact the ground with a long and wide footprint that is too big for use indoors. Tracked mobility devices may also require significant power to overcome the resistance of friction during movement, and can cause significant damage to carpets or floors when used indoors. Further, the turning radius of a tracked vehicle is typically larger than the turning radius of a wheeled vehicle due to the length of the track.

Applicant's U.S. Pat. No. 8,371,403 sought to address problems associated with prior art mobility vehicles by providing improvements to tracked mobility devices. Similarly, applicant's U.S. patent application Ser. No. 13/765,182 discloses other improvements to tracked mobility devices. In spite of those improvements though, a need continues to exist for improvements to personal mobility vehicle that will improve the low-friction, quick-turning, indoor and outdoor drivability of the device while still providing the superior off-road capability of a tracked vehicle. The present invention addresses that need.

### SUMMARY OF THE INVENTION

In one aspect of the present invention there is provided a tracked mobility device comprising: A tracked mobility device, comprising:
a) a frame supporting a seat assembly;
b) a pair of track drives connected to said frame, with each track drive comprising flexible track rotating around a set of wheels and/or rollers,
   wherein each set of wheels and/or rollers includes a rear powered wheel, a central weight-bearing wheel, and a front roller wheel;
   wherein each rear powered wheel, each central weight-bearing wheel, and each front roller/wheel are fixed to said frame at a height effective to cause each track drive always to have a “V”-shaped lower surface when viewed from the side, with the “V”-shape being defined by a raised front end portion, a raised rear end portion, and a lowered central portion, and never to have a flat lower surface when viewed from the side;
   wherein the raised rear end portion of each track contacts the rear surface of the powered drive wheel, the raised front end portion of each track contacts the front surface of the unpowered roller/wheel, and the lowered central portion of each track contacts only the lower surface of the central weight-bearing wheel, with the upper surface of the central weight-bearing wheel remaining free from contact with the track; and
c) an independent rear wheel assembly connected to said frame and comprising a rear wheel positioned at a fixed and constant height with respect to said frame, wherein said fixed and constant height is effective to allow the rear wheel to cooperate with the lowered central portion of each of said track drives to provide a three-point contact with a flat surface. A controller effective for controlling the speed and direction of rotation of each of the track drives is also preferably provided. In some embodiments the device the independent rear wheel has a diameter greater than the diameter of either weight-bearing wheel. In some embodiments the rear powered wheel of each track has a diameter greater than the diameter of the weight-bearing wheel of that track. In some embodiments each set of wheels and/or rollers additionally includes a non-weight-bearing and unpowered central roller/wheel between the rear powered wheel and the central weight-bearing wheel. In some embodiments the device additionally includes an arm rest on one side of the device, wherein said arm rest has a first, “up” position that blocks access to the seat from one side, and a second, “down” position that does not block access to the seat from that side. In some embodiments the device additionally includes a canopy mounted to the device to protect a user of the device from sun and/or rain. In some embodiments the seat assembly includes a seat and a footrest, and wherein the seat assembly is attached to the frame in a manner effective to be positioned in a first position that blocks access to the space beneath the seat, and in a manner effective to be positioned in a second position that allows access to the space beneath the seat.

### DESCRIPTION OF THE DRAWINGS

FIG. 1 is a side view of the tracked mobility device of the present invention according to one preferred embodiment.

FIG. 2 is a side elevational view of one embodiment of a drive track for the tracked mobility device of the present invention.

FIG. 3 is a perspective view of one embodiment of the tracked mobility device of the present invention according to one preferred embodiment.

FIG. 4 is a perspective view of a rear wheel assembly for the tracked mobility device of the present invention, according to one preferred embodiment.

FIG. 5 is a perspective view of an arm rest assembly for the tracked mobility device of the present invention, with the assembly in the “up” position, according to one preferred embodiment.

FIG. 6 is a perspective view of an arm rest assembly for the tracked mobility device of the present invention, with the assembly in the “down” position, according to one preferred embodiment.

FIG. 7 is a perspective view of a canopy assembly for the tracked mobility device of the present invention, according to one preferred embodiment.

FIG. 8 is a side view of the tracked mobility device of the present invention, according to one preferred embodiment, showing the seat assembly in its raised position to allow access to the space beneath the seat.

FIG. 9 is another side view of the tracked mobility device of the present invention according to one preferred embodiment.

FIG. 10 is a perspective view of the rear end portion of the tracked mobility device of the present invention, according to one preferred embodiment.

FIG. 11 is a perspective view of the seat connection assembly of the tracked mobility device of the present invention, according to one preferred embodiment.

FIG. 12 is a perspective view of a pneumatic seat suspension cup for a seat connection assembly of the tracked mobility device of the present invention, according to one preferred embodiment.

FIG. 13 is a perspective view of a track drive for the tracked mobility device of the present invention, according to one preferred embodiment.

FIG. 14 is a perspective view of components of a track drive for the tracked mobility device of the present invention, according to one preferred embodiment.

FIG. 15 is a perspective view of a track drive and a track tensioning assembly for the tracked mobility device of the present invention, according to one preferred embodiment.

FIG. 16 is a perspective view of components for a track tensioning assembly for the tracked mobility device of the present invention, according to one preferred embodiment.

FIG. 17 is a perspective view of components for a track tensioning assembly for the tracked mobility device of the present invention, according to one preferred embodiment.

FIG. 18 is a perspective view of components for a track tensioning assembly for the tracked mobility device of the present invention, according to one preferred embodiment.

FIG. 19 is a perspective view of components for a track tensioning assembly for the tracked mobility device of the present invention, according to one preferred embodiment.

### DESCRIPTION OF PREFERRED EMBODIMENTS

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

Applicant's co-pending U.S. patent application Ser. No. 13/765,182, filed Feb. 12, 2013, describes, inter alia, a tracked mobility device having two side tracks and an independent rear wheel assembly. Each side track assembly comprises or consists essentially of a powered drive wheel, two or more unpowered rollers, and a flexible track. The two side tracks have a “V”-shape along their bottom surfaces, with the lowest portion of the “V” being the portion that contacts a weight-bearing wheel. With the V-shaped side tracks and the independent rear wheel, the device contacts a flat, hard surface at three points: 1) the point at the bottom of the left side track below the weight-bearing wheel; 2) the point at the bottom of the right side track below the weight-bearing wheel; and 3) the point at the bottom of the rear wheel assembly. This “three-point” contact provides sufficient traction with reduced friction to improve drive efficiency.

Applicant's co-pending '182 application also discloses that when the device is on a soft and/or uneven surface, the device may contact the “ground” at three relatively larger areas: 1) the area starting at the bottom of the left side track below the weight bearing wheel and extending forward and/or rearward for a distance depending on the depth to which the left-side track has sunk in the soft surface; 2) the area starting at the bottom of the right side track below the weight bearing wheel and extending forward and/or rearward for a distance depending on the depth to which the right-side track has sunk in the soft surface; and 3) the area starting at the bottom of the rear wheel assembly and extending outward to include the area below the outer portions of the rear wheel assembly. This increased contact area provides superior traction in soft or uneven terrain, but only reduces drive efficiency when that increased traction is actually needed.

The present invention builds on applicant's '182 application by disclosing further improvements to the technology. In particular, the present invention provides a tracked mobility device comprising:
a) a frame supporting a seat assembly;
b) a pair of track drives connected to said frame, with each track drive comprising flexible track rotating around a set of wheels and/or rollers,
   wherein each set of wheels and/or rollers includes a rear powered wheel, a central weight-bearing wheel, and a front roller wheel;
   wherein each rear powered wheel, each central weight-bearing wheel, and each front roller/wheel are fixed to said frame at a height effective to cause each track drive always to have a “V”-shaped lower surface when viewed from the side, with the “V”-shape being defined by a raised front end portion, a raised rear end portion, and a lowered central portion, and never to have a flat lower surface when viewed from the side; and
c) an independent rear wheel assembly connected to said frame and comprising a rear wheel positioned at a fixed and constant height with respect to said frame, wherein said fixed and constant height is effective to allow the rear wheel to cooperate with the lowered central portion of each of said track drives to provide a three-point contact with a flat surface.

In the most preferred embodiments the raised rear end portion of each track contacts the rear surface of the powered drive wheel, the raised front end portion of each track contacts the front surface of the unpowered roller/wheel, and the lowered central portion of each track contacts only the lower surface of the central weight-bearing wheel. In such embodiments the upper surface of the central weight-bearing wheel is free from contact with the track.

A controller effective for controlling the speed and direction of rotation of each of the track drives is also preferably provided. In some embodiments the device the independent rear wheel has a diameter greater than the diameter of either weight-bearing wheel. In some embodiments the rear powered wheel of each track has a diameter greater than the diameter of the weight-bearing wheel of that track. In some embodiments each set of wheels and/or rollers additionally includes a non-weight-bearing and unpowered central roller/wheel between the rear powered wheel and the central weight-bearing wheel. In some embodiments the device additionally includes an arm rest on one side of the device, wherein said arm rest has a first, “up” position that blocks access to the seat from one side, and a second, “down” position that does not block access to the seat from that side. In some embodiments the device additionally includes a canopy mounted to the device to protect a user of the device from sun and/or rain. In some embodiments the seat assembly includes a seat and a footrest, and wherein the seat assembly is attached to the frame in a manner effective to be positioned in a first position that blocks access to the space beneath the seat, and in a manner effective to be positioned in a second position that allows access to the space beneath the seat.

As in applicant's co-pending '182 application, this written description may refer to a contact “point” or a contact “area” or some other zone or surface of contact. However, it is to be appreciated that even when the device is on a completely hard and flat surface, the contact “points” are actually small areas that are typically substantially linear according to the width of the relevant wheel and/or track. Accordingly, applicant's reference to one or more contact “points” is not intended to be literally limited to points of contact, but is instead intended to refer to the relatively small contact areas that obtain when the device is standing or moving on a flat, hard surface.

Reference will now be made to various embodiments and/or features. It is to be appreciated that any or all of these embodiments and/or features may be used alone or in combination with any other embodiment or feature described herein or disclose in applicant's co-pending U.S. patent application Ser. No. 12/849,897 or in applicant's co-pending U.S. patent application Ser. No. 13/765,182. For example, the side track assemblies disclosed herein may be mounted directly to a frame, or they may be mounted to a frame with the independent mounting assemblies previously shown and described.

1. The Track Drive.

Two track drives are preferably used on the inventive mobility device. Each track drive preferably comprises a powered rear drive wheel, an unpowered central weight-bearing wheel, at least one additional roller, and a flexible track.

A powered drive wheel is preferably provided at one end of the track. In the most preferred embodiment the powered drive wheel is provided at the rear end of the track, but it alternatively may be provided at the front end of the track.

The powered drive wheel is preferably a “sprocket-drive” wheel holes extending through the surface to cooperates with corresponding spikes on the inner surface of the flexible track band. The sprocket drive configuration allows the drive wheel to grip the flexible track band to avoid slipping. Alternatively, the powered drive wheel can have a flat outer surface, or a ridged outer surface with a ridge spacing effective to cooperate with corresponding ridges on the track.

Each powered drive wheel functions to turn the flexible track of a track drive, thereby moving the device in either a forward or a rearward direction. Each drive wheel is capable of moving at a variable speed in either a forward or a rearward direction.

The drive wheel is preferably powered by a motor that is mounted to the vehicle frame. The motor is effective for turning a drive shaft or axle, which turns the drive wheel. The motor may be an electric motor such as an AC- or DC-battery powered motor. The motor is effective for moving the drive shaft/axle and associated track in the forward or rearward direction.

Each motor preferably drives one drive shaft, which preferably comprises a ¾ inch axle. The drive shaft may be driven directly by the motor, or it may be driven by a mechanical linkage. Gears to adjust the rotational speed of the drive shaft are preferably included.

The powered drive wheel preferably has an outer diameter of between 6 inches and 14 inches, with a diameter of between about 8 inches and 12 inches, and most preferably at least about 10 inches, being more preferred.

An unpowered front roller wheel is preferably provided at the other end of the track. The unpowered front roller wheel is preferably a free-rolling roller that extends the track distance and properly positions the front track end without restricting track movement. The front roller preferably has a diameter between about 2 inches and 8 inches, and more preferably between about 4 inches and 6 inches, and most preferably about 5 inches.

A central weight-bearing wheel is preferably located between the powered drive wheel and the unpowered front roller wheel. As discussed herein, the central weight-bearing wheel is preferably attached to the frame at a position effective to cause the bottom portions of the drive wheel, roller wheel, and weight-bearing wheel to form a shallow “V” shape. The central weight-bearing wheel preferably defines the lower angled portion of that “V.”

The central weight-bearing wheel preferably has a diameter of between about 4 inches and 8 inches, with a diameter of about 6 inches being most preferred.

One or more additional non-powered, non-weight-bearing wheels may also be provided in the track. These roller wheels may help to keep the flexible track band aligned and moving smoothly over the track. Such roller wheels preferably have a diameter of between about 3 inches and 8 inches, with a diameter of about 4 to 6 inches being most preferred.

As discussed herein, the centers (axle height) of the various wheels/rollers are positioned at a height effective to cause the track to form a shallow “V”-shape along its lower surface. When so positioned, the track will contact a flat, level ground surface only at a single “point” or small area that is less than the diameter of the weight-bearing wheel.

In one embodiment one or more of the wheels may include a groove to facilitate alignment of the track. In other embodiments the track may be aligned on the drive wheel and rollers with an alignment guide that keeps the track centered over the drive wheel and rollers.

Each track comprises a flexible track band that moves continuously as the drive wheel rotates. The tracks may be made of any material with the flexibility and strength to drive a personal mobility vehicle over grass, gravel, concrete, wood, carpet, etc., and is preferably made of a heavy-weight rubber or synthetic material such as is used to make automobile tires. The material preferably includes fibers woven into the material, such as metal, nylon or other synthetic fibers.

In the preferred embodiment the flexible track band has openings that cooperate with similarly-spaced spikes in the drive wheel to facilitate gripping between the track and the drive wheel. This configuration may be referred to as a sprocket drive. The sprocket drive works similarly to a sprocket and chain connection found in bicycles and the like to avoid slippage between the flexible track band and the drive wheel.

In another embodiment the flexible track band may have a cross section shaped as a “T’ so that the track can be aligned in grooves in the drive wheel and/or the idler and/or carrier rollers. When the tracks have a “T’-shaped cross section, the track defines a horizontal portion and a vertically-extending portion. The horizontal portion may have a width that extends slightly beyond the width of the rollers, such as a four-inch-wide track for three-inch-wide rollers. The vertically-extending portion is sized to be accepted in grooves of the rollers, and is accordingly preferably about ¾ inch tall. In one embodiment the vertical portion of the “T” has a tapered shape to facilitate alignment with the roller grooves. In that embodiment it is preferred that the vertical end (bottom) portion of the “T” is slightly more narrow than the (upper) portion of the “T” that connects with the horizontal portion of the track. For example, the bottom end portion may be ½ inch wide when the upper portion that connects with the horizontal part of the track is ¾ inch wide.

As indicated above and as shown in the drawings, the flexible track contacts the ground at a small “point” under each center drive wheel when the device is standing or moving on a hard, flat surface. Conversely, the flexible track contacts the ground at a larger contact “area” under the center drive wheel and extending forward toward the front roller and rearward toward the rear roller when the device is standing or moving on a soft and/or uneven surface. The extended or enlarged contact area keeps the vehicle from sinking too far into the soft terrain much like snow shoes keep a person from sinking into soft snow.

The track drive may be adjustable in length to allow the proper tension to be maintained on the flexible track band. In one embodiment a “take-up” assembly is used to allow the front roller wheel to be moved forward or backward to maintain the proper tension on the track band. The take-up mechanism may include a bolt that is turned to advance an arm that moves the roller wheel forward or back.

2. The Rear Wheel Assembly.

The mobility device also includes a rear wheel assembly that functions as the third contact point when the vehicle is on a hard, flat surface. The rear wheel assembly preferably comprises an inner wheel portion having an inner wheel diameter, and a pair of outer wheel portions having a diameter that is smaller, and is preferably at least 10% smaller, than the inner wheel diameter.

In one embodiment the independent rear wheel assembly comprises three wheels sharing a common axle. The three wheels may therefore be identified as the center or inner rear wheel, and the two outer rear wheels. A generally vertical fork assembly, which may include an offset portion, may be used to connect the axle(s) to the frame.

The center rear wheel preferably has a diameter of between 8 inches and 12 inches, with a diameter of about 10 inches being more preferred. The two outer wheels preferably have a diameter of between 6 inches and 10 inches, with a diameter of about 8 inches being more preferred.

In the most preferred embodiments the first outer wheel has a diameter at least 10% smaller than the diameter of the center rear wheel. Similarly, the second outer wheel preferably has a diameter at least 10% smaller than the diameter of the center rear wheel. In alternative embodiments the two outer rear wheels have a diameter at least 20% smaller than the diameter of the center rear wheel.

As shown in the drawings, the rear wheel assembly contacts the ground at a small “point” under the center rear wheel when the device is standing or moving on a hard, flat surface. Conversely, the rear wheel assembly contacts the ground at a larger contact “area” under the center rear wheel and the two outer rear wheels when the device is standing or moving on a soft and/or uneven surface. This larger contact area keeps the vehicle from sinking too far into the soft terrain much like snow shoes keep a person from sinking into soft snow.

The rear wheel assembly is preferably connected to the vehicle frame with a fork that pivots with respect to the frame. This allows the rear wheels to track properly regardless of the direction in which the vehicle is moving. The fork preferably allows the wheel to freely rotate about 360°, thus enabling the wheel to roll in any direction. This makes it possible to easily move the device in any direction without changing its orientation. Most preferably the fork includes a small amount of offset distance between the center axis of the vertical shaft and the center axis of the wheel. If the wheel pushed to move in a direction that is not the direction that the wheel is facing, the offset will cause the wheel assembly to rotate around the axis of the vertical shaft to follow behind the direction of movement. Thus, when in motion along a straight line, the independent rear wheel assembly will tend to automatically align to, and rotate parallel to, the direction of travel.

3. The Frame/Body and Controls

The mobility device includes a frame or body to which the two track drives and the rear wheel assembly are attached. The frame/body may be made of metal, plastic, composite, or some other material appropriate for covering the elements that are housed in the body.

The dimensions of the body may vary according to the desired size of the device, but in one preferred embodiment the body has a length of about 22 inches to 24 inches, and a width of about 16 inches to 18 inches. The height of the frame is preferably between about 10 inches and about 16 inches.

In one embodiment the body supports a seat. The seat may be a bench seat, or it may have a back. Arms may be included if desired, and may be sized to accommodate controls that are easily accessible by the user's hand(s).

The device may include controls to control the direction and speed at which each track moves. The device may also include controls to control the actuator(s) which lower the multi-directional wheel(s). The controls may be operated by a joystick which moves forward to move both tracks forward, or moves backward to move both tracks backward, or moves to the left to move the right track forward and the left track backward, or moves to the right to move the left track forward and the right track backward, or any combination of speed and direction for each track. Joystick controls which control the speed and direction of rotation of each drive shaft, and thus of each track, are known to the art. Alternatively, other controls effective to control the speed and/or direction of rotation of each track may be incorporated into the device. Additionally, readouts such as LED readouts to indicate operating conditions such as battery life may be included.

In one embodiment arm rests are provide on the device. Such arm rests may be movable so that they may swing down and out-of-the-way when a user is climbing onto or off of the device.

A seat assembly is also provided on the device. The seat assembly includes a seat, and may also include a foot rest for the user's feet. The seat assembly may be provided with an actuator that allows the seat to be raised or lowered, with adjustment to seat angle also being provided. In one embodiment the seat assembly is provided with a suspension system including a pneumatic cup that allows air pressure to be used to provide a comfortable seat suspension.

In one embodiment of the present invention the seat is pivotable on the frame. Most preferably, the seat is pivotable for at least about 90° in each direction to enable a user to enter and/or exit the vehicle more easily from the side. When side hand rails are included, the complete seat assembly, including handrails, may be pivotable with respect to the frame. Moreover, the seat may be movable to allow access to the space beneath the seat. That space may be used to stow gear, and/or it may be used to hold batteries to power the motor.

In an alternative embodiment of the present invention the front “roller wheel” may be a powered wheel, and the center and rear wheels/rollers may be unpowered. In that embodiment the front surface of the powered front wheel will contact the front end portion of the flexible track.

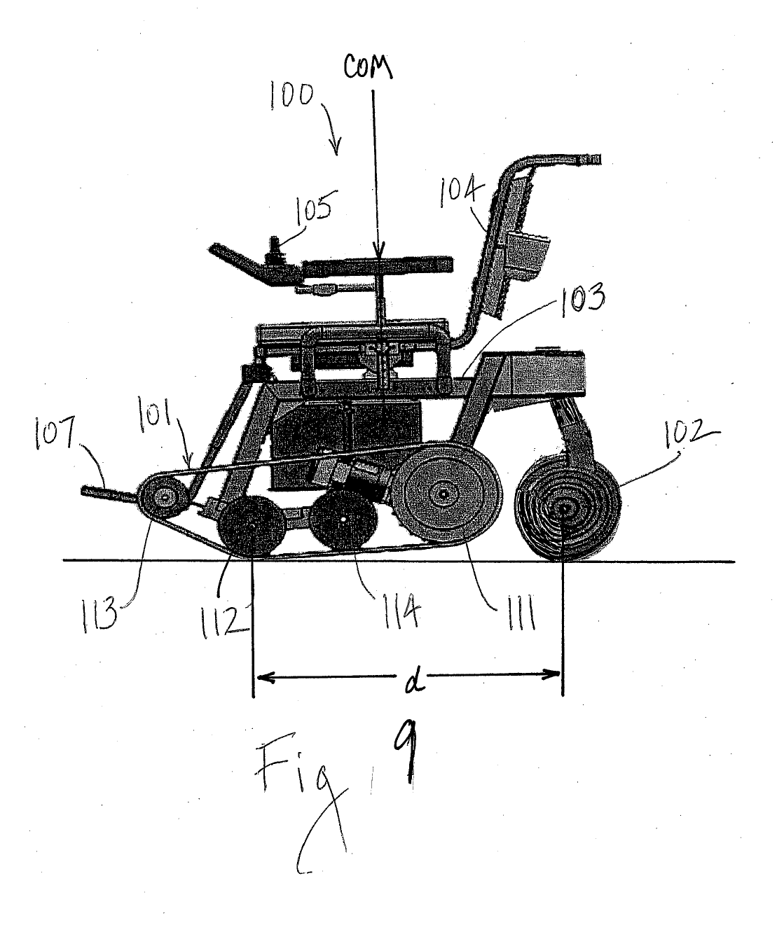

The inventive mobility device preferably has a track length of about 24 inches, and more preferably between about 36 inches and 48 inches. When combined with the independent rear wheel assembly, the device contacts the ground at three points as disclosed herein, with the distance “d” between the two, front-most ground contact points and the single, rearmost ground contact point being between about 22 inches and 32 inches, more preferably between about 24 inches and 30 inches, and most preferably about 28 inches, when viewed from the side as shown in FIG. 9.

The center of gravity (or center of mass) of the device is between those contact points, with the center of gravity/center of mass being at least 8 inches in front of the rearmost ground contact point and at least 8 inches behind the front-most ground contact point. More preferably, the center of gravity/center of mass is at least 10 inches in front of the rearmost ground contact point and at least 10 inches behind the front-most ground contact point to provide improved stability, and most preferably, the center of gravity/center of mass is at least 12 inches in front of the rearmost ground contact point and at least 12 inches behind the front-most ground contact point. In one preferred embodiment the center of gravity/center of mass is about 13 inches in front of the rearmost ground contact point and about 15 inches behind the front-most ground contact point.

Similarly, when a user is seated in the device, the center of gravity of the device/user combination must be between the three contact points, with the center of gravity/center of mass of a device/user combination being at least 8 inches in front of the rearmost ground contact point and at least 8 inches behind the front-most ground contact point with a 150 pound user. More preferably, the center of gravity/center of mass of the device/user combination is at least 10 inches in front of the rearmost ground contact point and at least 10 inches behind the front-most ground contact point (with a 150 pound user) to provide improved stability, and most preferably, the center of gravity/center of mass is at least 12 inches in front of the rearmost ground contact point and at least 12 inches behind the front-most ground contact point. In one preferred embodiment the center of gravity/center of mass of the device/user combination is about 13 inches in front of the rearmost ground contact point and about 15 inches behind the front-most ground contact point.

Similarly, to provide improved stability when a user is seated in the device, the seat should be positioned so that the center of the seat is at least 8 inches in front of the rearmost ground contact point and at least 8 inches behind the front-most ground contact point. More preferably, the center of the seat is at least 10 inches in front of the rearmost ground contact point and at least 10 inches behind the front-most ground contact point to provide improved stability, and most preferably, the center of the seat is at least 12 inches in front of the rearmost ground contact point and at least 12 inches behind the front-most ground contact point. This prevents the device from tipping forward or backward when a user leans forward or backward in the seat.

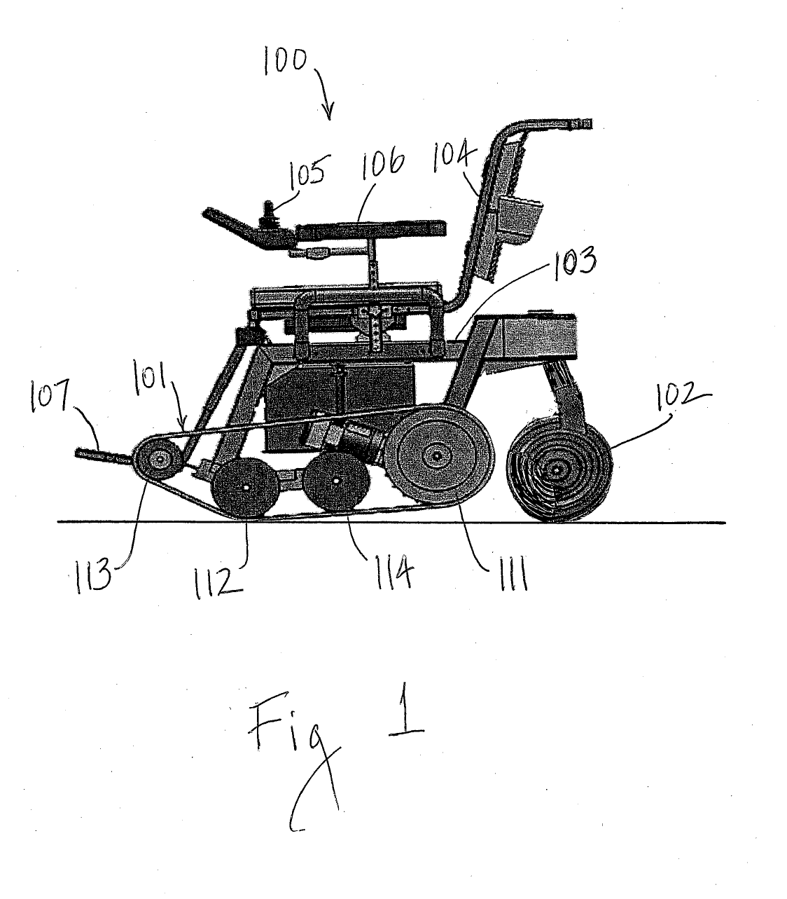

Referring now to the drawings, FIG. 1 shows the tracked mobility device of the present invention according to one preferred embodiment. Tracked mobility device 100 includes a pair of track drives 101 and a rear wheel assembly 102 mounted to a frame 103. Each track drive 101 comprises a flexible track 115 rotating around a set of wheels and/or rollers. Each set of wheels and/or rollers includes a rear powered wheel 111, a central weight-bearing wheel 112, and a front roller/wheel 113. An additional central non-powered, non-weight-bearing roller wheel 114 is also included between rear powered wheel 111 and central weight-bearing wheel 112.

Each rear powered wheel, each central weight-bearing wheel, and each front roller wheel are fixed to said frame at a height effective to cause each track drive always to have a “V”-shaped lower surface when viewed from the side, with the “V”-shape being defined by a raised front end portion, a raised rear end portion, and a lowered central portion, and never to have a flat lower surface when viewed from the side. The raised rear end portion of each track contacts the rear surface of the powered drive wheel, and the raised front end portion of each track contacts the front surface of the unpowered roller wheel. The lowered central portion of each track contacts only the lower surface of the central weight-bearing wheel, with the upper surface of the central weight-bearing wheel being free from contact with the track.

Rear wheel assembly 102 is connected to the frame and comprises a rear wheel positioned at a fixed and constant height with respect to the frame. That fixed and constant height is effective to allow the rear wheel to cooperate with the lowered central portion of each of said track drives to provide a three-point contact with a flat surface.

A seat assembly 104 is also provided on the frame. Seat assembly 104 optionally includes a foot rest 107.

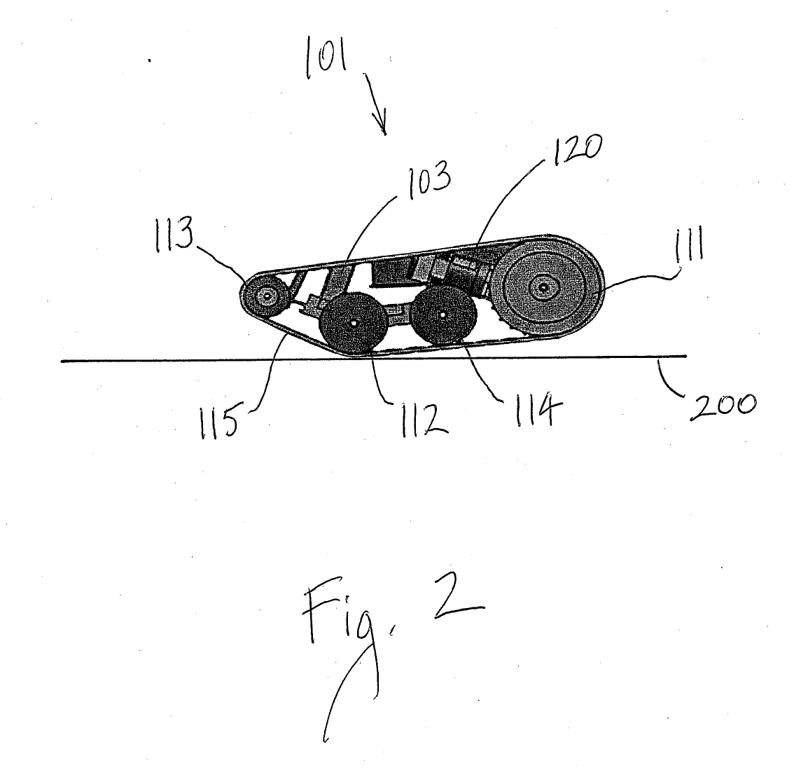

FIG. 2 is a side elevational view of one embodiment of a drive track for the tracked mobility device of the present invention. Drive track 101 includes a flexible track 115 rotating around a set of wheels and/or rollers. Each set of wheels and/or rollers includes a rear powered wheel 111, a central weight-bearing wheel 112, and a front roller/wheel 113. An additional central non-powered, non-weight-bearing roller wheel 114 is also included between rear powered wheel 111 and central weight-bearing wheel 112. A motor 12o powers drive wheel 111. Weight-bearing wheel 112 is mounted to frame 103 so that weight-bearing wheel 112 may cooperate with independent rear wheel 102 to support all of the weight of the device. It can be seen that the bottom surface of track drive 101 forms a shallow “V” with respect to flat ground 200.

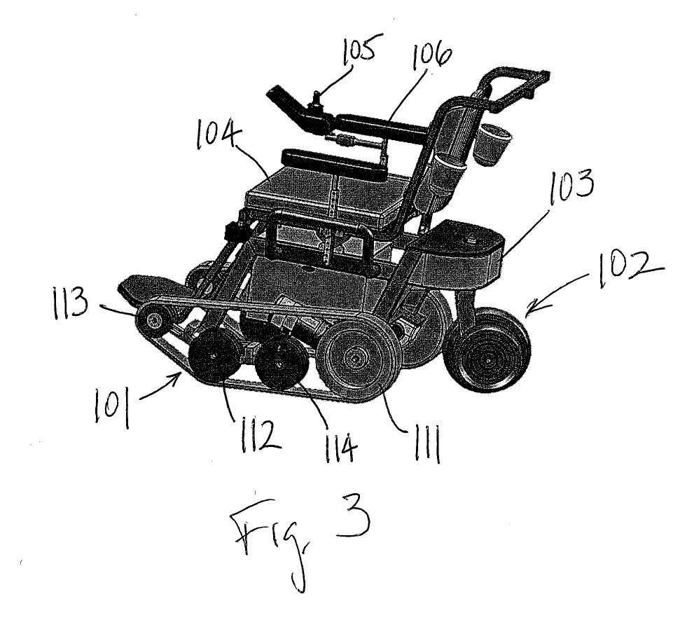

FIG. 3 is a perspective view of one embodiment of the tracked mobility device of the present invention according to one preferred embodiment. Tracked mobility device 100 includes a pair of track drives 101 and a rear wheel assembly 102 mounted to a frame 103. Each track drive 101 comprises a flexible track 115 rotating around a set of wheels and/or rollers. Each set of wheels and/or rollers includes a rear powered wheel 111, a central weight-bearing wheel 112, and a front roller wheel 113. An additional central non-powered, non-weight-bearing roller wheel 114 is also included between rear powered wheel 111 and central weight-bearing wheel 112. A controller 105 effective for controlling the speed and direction of rotation of each of the track drives is also provided. Additionally, arm rests 106 are provided on each side of the device

FIG. 4 is a perspective view of an independent rear wheel assembly for the tracked mobility device of the present invention, according to one preferred embodiment. The illustrated independent rear wheel assembly 102 includes a central wheel 121 and a pair of outer wheels 122, with all three wheels being mounted to a single axle. The assembly is attached to frame 103 in a manner effective to allow rear wheel assembly 102 to pivot as necessary to have central wheel 121 roll in a desired direction. The illustrated connection comprises a generally vertical pivot assembly 117, which includes an offset fork portion 118, to connect the axle to the frame.

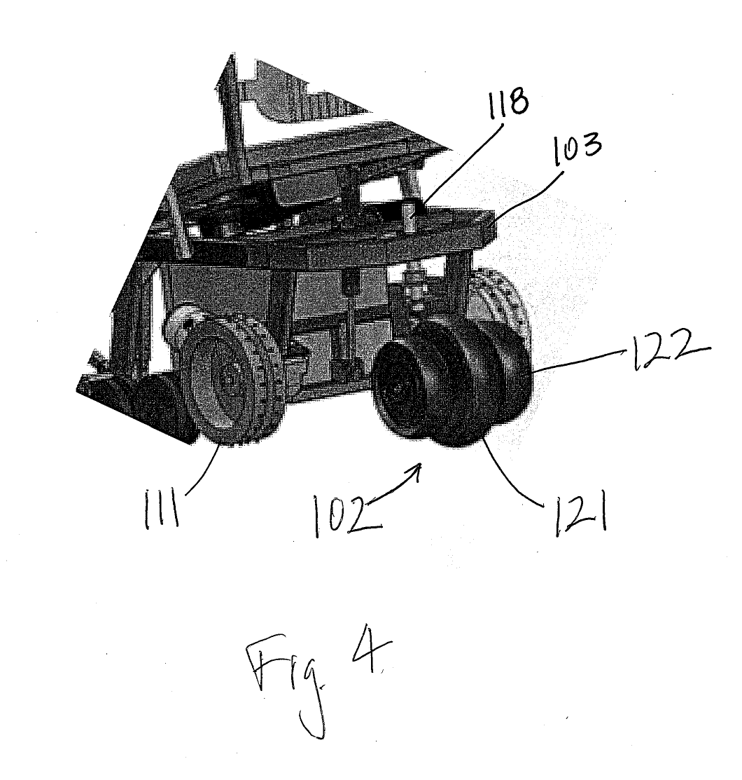

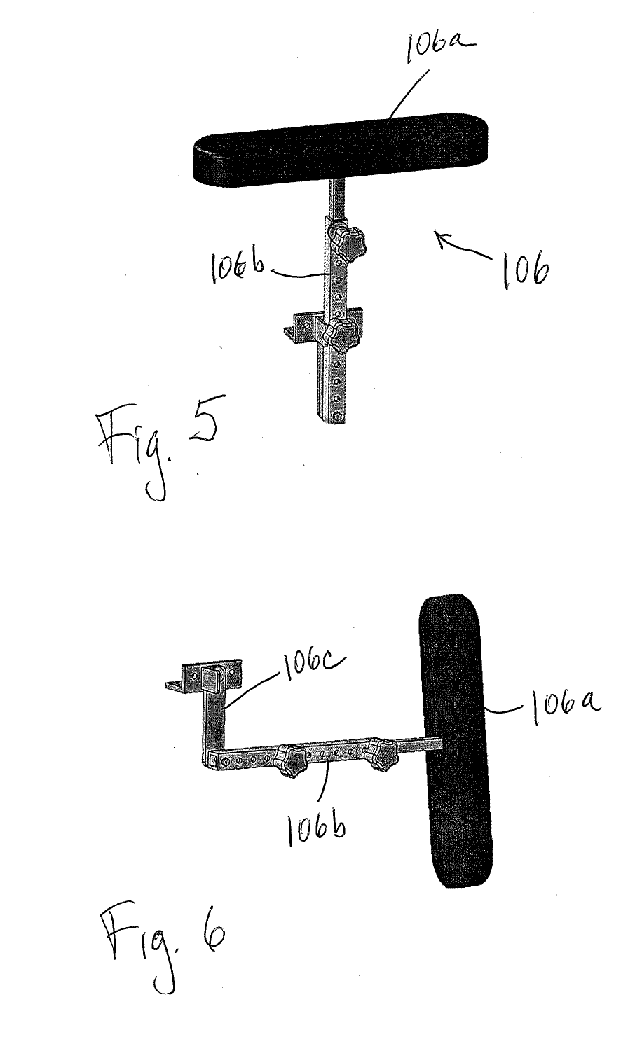

FIG. 5 is a perspective view of an optional arm rest assembly 106 for the tracked mobility device of the present invention, with the assembly in the “up” position. FIG. 6 is a perspective view of arm rest assembly 106 in its “down” position. In both Figures, arm rest assembly 106 includes a rest portion 106a mounted to a swivel arm 106b. Swivel arm 106b is mounted to and swivel with respect to a support 106c. Swivel arm 106b may be locked in its “up” position when in use, or it may be allowed to swivel down and out of the way when a user is climbing onto or down from the mobility device.

FIG. 7 is a perspective view of a canopy assembly for the tracked mobility device of the present invention, according to one preferred embodiment. Canopy assembly 140 may protect a user from sun and/or rain when the mobility device is used outdoors.

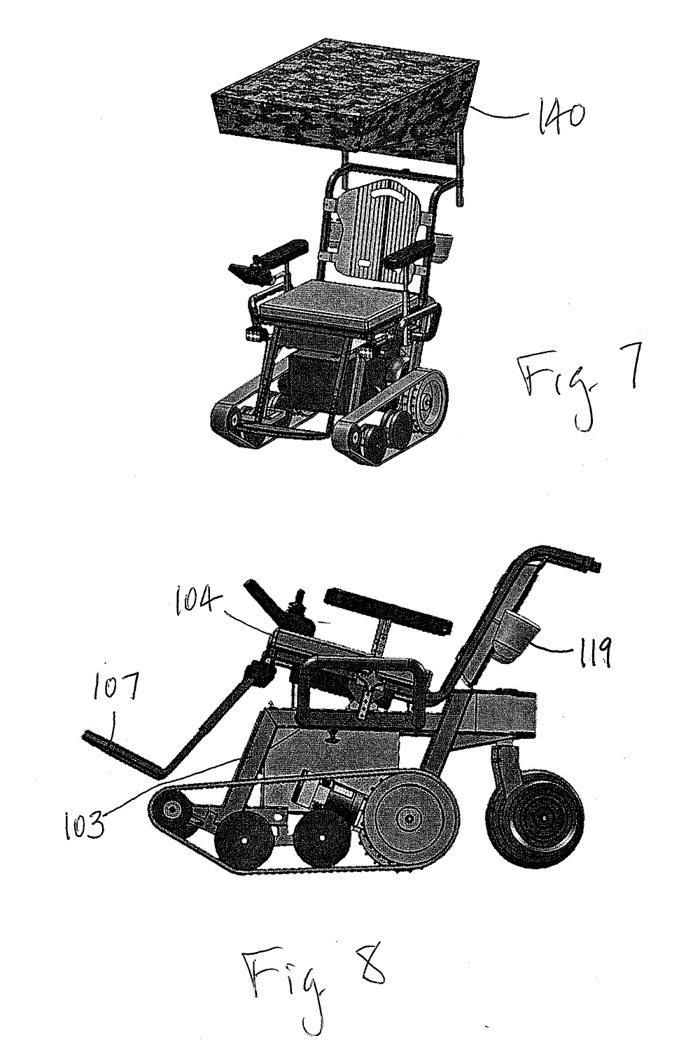

FIG. 8 is a side view of the tracked mobility device of the present invention, according to one preferred embodiment, showing the seat assembly in its raised position to allow access to the space beneath the seat.

FIG. 9 is another side view of the tracked mobility device of the present invention according to one preferred embodiment. In addition to the components previously discussed, a controller 105 effective for controlling the speed and direction of rotation of each of the track drives is illustrated. Additionally, a cup holder 119 is provided. The device illustrated in FIG. 9 is moving backward, as can be seen from the position of the independent rear wheel assembly fork.

As also shown in FIG. 9, the device contacts the ground at three points, with the distance “d” between the front-most ground contact points under the weight-bearing wheel and the rearmost ground contact point under the independent rear wheel being between about 22 inches and 32 inches when viewed from the side as illustrated.

As also shown in FIG. 9, the device has a center of mass “COM” that typically is near the center of the seat. The center of mass may move forward or backward slightly when a user is seated in the device, but that movement is not significant for a 150 to 250 pound user. Center of mass COM is preferably at least 10 inches behind the front end of distance “d” and at least 10 inches in front of the rear end of distance “d,” and is more preferably at least 12 inches behind the front end of distance “d” and at least 12 inches in front of the rear end of distance “d.”

FIG. 10 is a perspective view of the rear end portion of the tracked mobility device of the present invention, according to one preferred embodiment. Rear wheel assembly 102 is shown, including center rear wheel 121 and outer rear wheel 122. Powered drive wheel 111 is also illustrated.

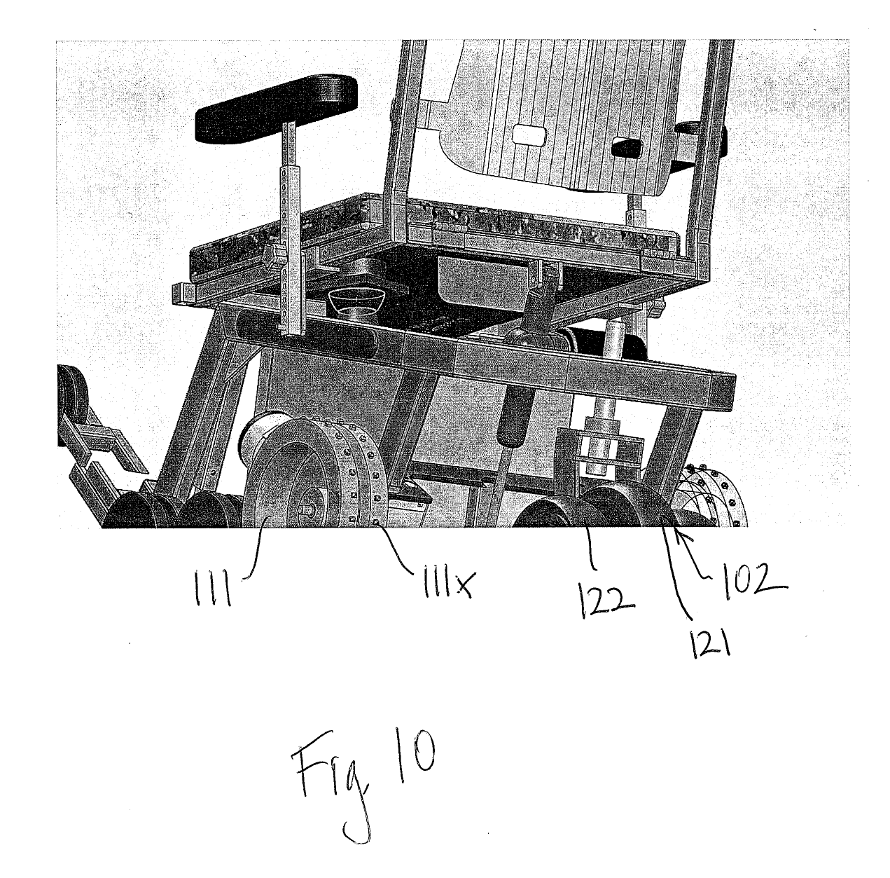

FIG. 11 is a perspective view of the seat connection assembly of the tracked mobility device of the present invention, according to one preferred embodiment. Seat connection assembly 150 includes seat actuator 151 and pneumatic seat suspension cup 152.

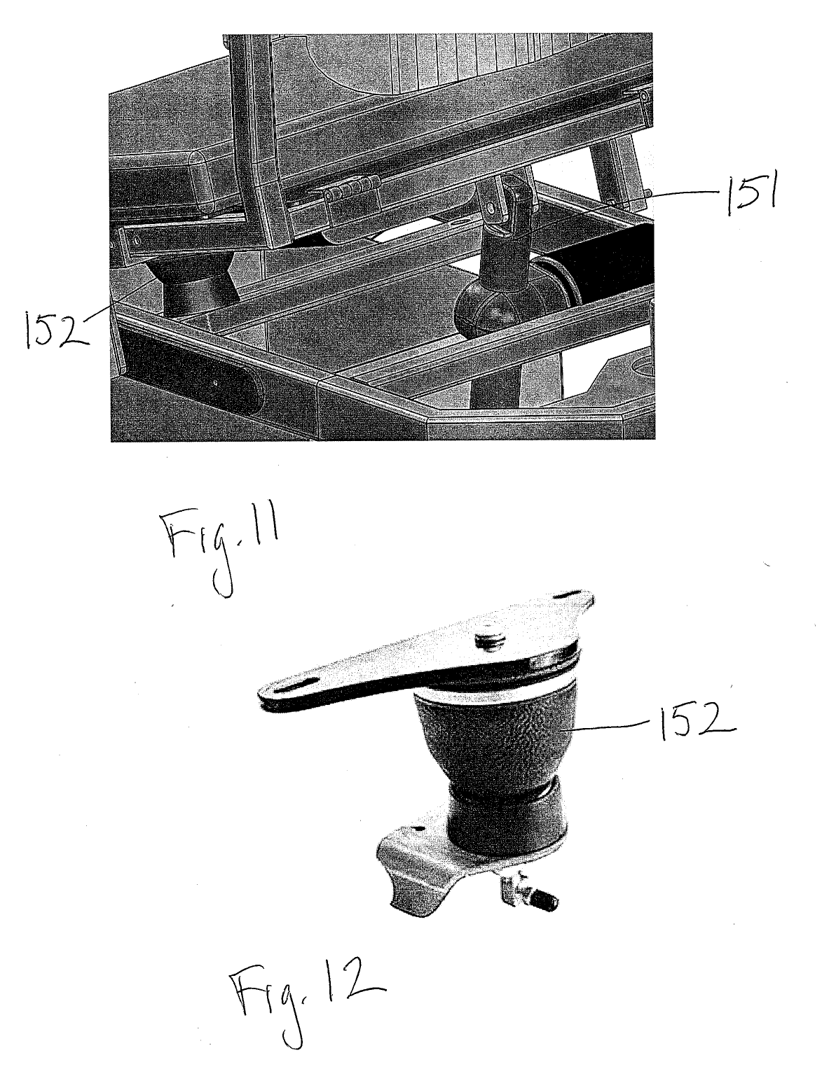

FIG. 12 is a perspective view of a pneumatic seat suspension cup 152 for a seat connection assembly of the tracked mobility device of the present invention, according to one preferred embodiment.

FIG. 13 is a perspective view of a track drive for the tracked mobility device of the present invention, according to one preferred embodiment. The interlinking connection between drive wheel spikes 111x and flexible track band openings 111y is shown.

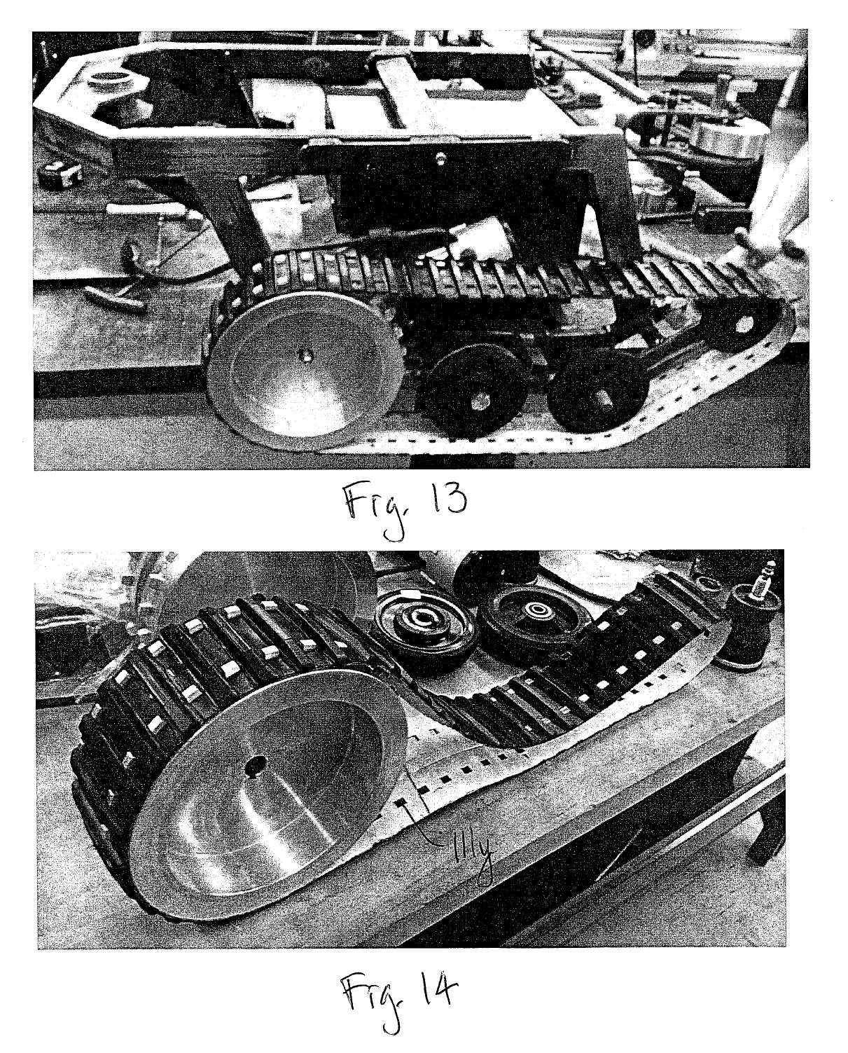

FIG. 14 is a perspective view of components of a track drive for the tracked mobility device of the present invention, according to one preferred embodiment. Here too, the interlinking connection between drive wheel spikes 111x and flexible track band openings 111y is shown.

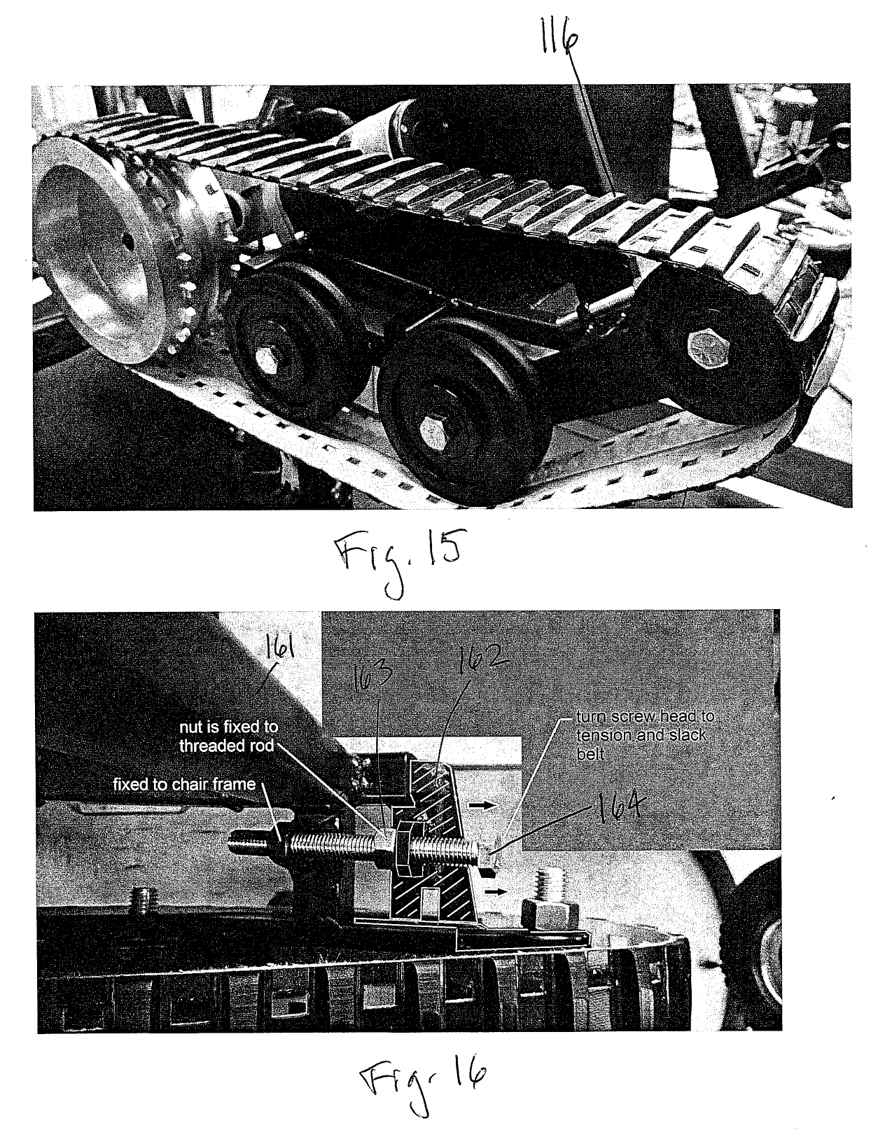

FIG. 15 is a perspective view of a track drive and a track tensioning assembly for the tracked mobility device of the present invention, according to one preferred embodiment. The outer ridges 116 on flexible track band 115 are particularly illustrated.

FIG. 16 is a perspective view of components for a track tensioning assembly for the tracked mobility device of the present invention, according to one preferred embodiment. Track length adjustment assembly 160 includes a fixed bracket 161 and a movable bracket 162. Movable bracket 162 slides in fixed bracket 161, and may be moved and locked in place by turning a bolt 164. A nut 163 locks bolt 164 when the correct tension is achieved.

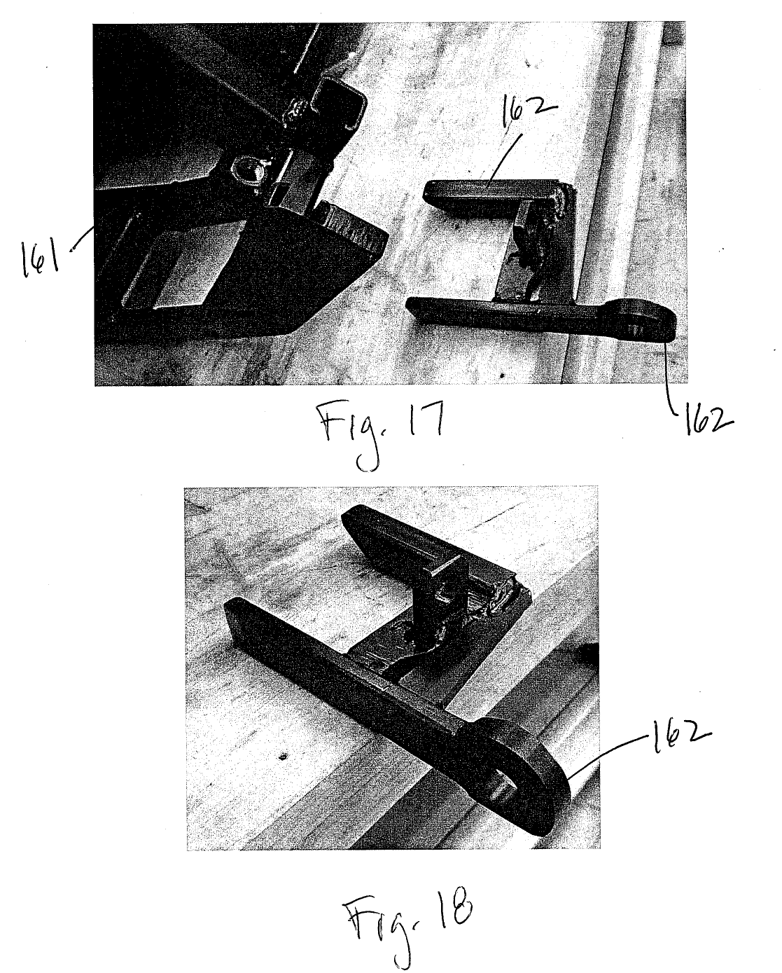

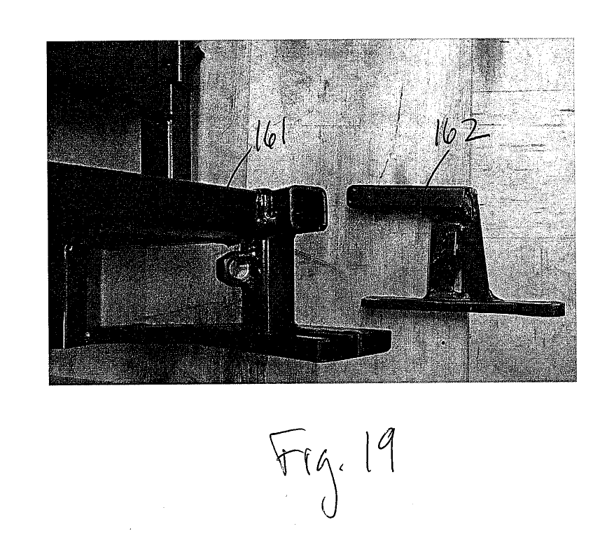

FIG. 17-19 show additional perspective views of components for a track tensioning assembly for the tracked mobility device of the present invention, according to one preferred embodiment. Fixed bracket 161 and movable bracket 162 are particularly shown.

While the invention has been illustrated and described in detail in the drawings and foregoing description, the same are to be considered illustrative and not restrictive in character, it being understood that only the preferred embodiments are shown and described and that all changes and modifications that come within the spirit of the invention are desired to be protected. In addition, it is to be appreciated that the present invention may comprise or consist essentially of any or all of the illustrated features. For example, the present invention includes devices comprising any or all of the features illustrated in FIGS. 1 through 9, and the present invention includes devices consisting essentially of any of any or all of those features Additionally, all of the features and/or embodiments disclosed in U.S. patent application Ser. No. 13/765,182, and/or in U.S. Pat. No. 8,371,403, both of which are incorporated herein by reference, may be combined with any or all of the features disclosed herein to provide a device that comprises or consists essentially of such features.

1. A tracked mobility device, comprising:
a) a frame supporting a seat assembly;
b) a pair of track drives connected to said frame, with each track drive comprising flexible track rotating around a set of wheels and/or rollers,
wherein each set of wheels and/or rollers includes a powered rear drive wheel, an unpowered central weight-bearing wheel, and an unpowered front roller wheel;
wherein the powered rear drive wheel, unpowered central weight-bearing wheel, and unpowered front roller wheel of each track are fixed to said frame at a height effective to cause each track drive always to have a “V”-shaped lower surface when viewed from the side, with the “V”-shape being defined by a raised front end portion, a raised rear end portion, and a lowered central portion, and never to have a flat lower surface when viewed from the side;
wherein the rear end portion of each track contacts the rear surface of the powered rear drive wheel, the front end portion of each track contacts the front surface of the unpowered front roller wheel, and the lowered central portion of each track contacts only the lower surface of the central weight-bearing wheel, with the upper surface of the central weight-bearing wheel being free from contact with the track;
c) an independent rear wheel assembly connected to said frame and comprising a rear wheel positioned at a fixed and constant height with respect to said frame, wherein said fixed and constant height is effective to allow the rear wheel to cooperate with the lowered central portion of each of said track drives to provide a three-point contact with a flat surface; and
d) a controller effective for controlling the speed and direction of rotation of each of the track drives.

2. The tracked mobility device of claim 1 wherein the rear powered wheel of each track has a diameter greater than the diameter of the weight-bearing wheel of that track.

3. The tracked mobility device of claim 1 wherein the rear wheel of said rear wheel assembly has a diameter greater than the diameter of either weight-bearing wheel.

4. The tracked mobility device of claim 1 wherein each set of wheels and/or rollers additionally includes a non-weight-bearing and unpowered central roller wheel between the rear powered wheel and the central weight-bearing wheel.

5. The tracked mobility device of claim 1 wherein the device additionally includes an arm rest on one side of the device, wherein said arm rest has a first, “up” position that blocks access to the seat from one side, and a second, “down” position that does not block access to the seat from that side.

6. The tracked mobility device of claim 1 wherein the device additionally includes a canopy mounted to the device to protect a user of the device from sun and/or rain.

7. The tracked mobility device of claim 1 wherein said seat assembly includes a seat and a footrest, and wherein the seat assembly is attached to the frame in a manner effective to be positioned in a first position that blocks access to the space beneath the seat, and in a manner effective to be positioned in a second position that allows access to the space beneath the seat.

8. The tracked mobility device of claim 1 wherein the center of gravity is at least 12 inches in front of the rearmost ground contact point and at least 12 inches behind the front-most ground contact point.

9. The tracked mobility device of claim 1 wherein the seat of the device is positioned at least 12 inches in front of the rearmost ground contact point and at least 12 inches behind the front-most ground contact point.
